(19) United States
(12) Patent Application Publication
(10) Pub. No.: US 2007/0273914 A1
(43) Pub. Date: Nov. 29, 2007

(54) IMAGE FORMING APPARATUS, CONTROL METHOD THEREFOR, AND PROGRAM

(75) Inventor: Osamu Hosoda, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/746,042

(22) Filed: May 8, 2007

(30) Foreign Application Priority Data
May 23, 2006 (JP) 2006-143384

(51) Int. Cl. G06K 15/00

(52) U.S. Cl. 358/1.14

(57) ABSTRACT

When the second job to be processed by interrupting the first job is input, a blank area is discriminated where the first image based on the first job is not laid out on a printing medium. It is determined whether the second image based on the second job can be laid out in the discriminated blank area of the printing medium. When it is determined that the second image can be laid out in the blank area on the printing medium, printing is controlled so as to form the first and second images on the printing medium.

### BACKGROUND OF THE INVENTION

1. Field of the Invention

The present invention relates to an image forming apparatus which prints an image on a printing medium on the basis of a job associated with printing.

2. Description of the Related Art

Along with the advent of high-speed, high-quality electrophotographic printing devices and ink-jet printing devices, a so-called print-on-demand market prevails. Print-on-demand will be abbreviated as POD hereinafter.

The POD aims at handling the print process within a short delivery period by dividing a job to be handled by a printing device into those of relatively smaller lots without using any large-scale device or system. Especially, this POD implements digital prints using digital data by fully utilizing a digital image forming device such as a digital copying machine or digital multifunction peripheral in place of the large-scale printing press and printing scheme. A POD market as a POD-based business category has been developed.

Such POD market merges digitalization compared to the conventional printing business, effectively utilizes computerized management and control, and makes an attempt to reach the conventional printing business level using computers.

In such situation, PFP as a print service of a copy/print shop, CRD as an in-house print service, and the like are known in the POD market. Note that PFP is short for Print For Pay, and CRD is short for Centralized Reproduction Department.

The print process in the POD market sometimes inputs a plurality of jobs at once to an image forming apparatus, or inputs a high-priority job during execution of a large-volume job. In this case, the image forming apparatus requires a control function to determine which job is to be processed preferentially.

When the image forming apparatus receives a new job of high print priority during the print process, its control function which considers the print priority of a job suspends a preceding job to execute the print process of the high-priority succeeding job. Upon completion of the print process of the succeeding job, the control function resumes the suspended preceding job.

Japanese Patent Laid-Open No. 11-212750 discloses a configuration of efficiently performing the print process. According to the configuration disclosed in Japanese Patent Laid-Open No. 11-212750, a print control apparatus generates print data so as to print data of two pages on a sheet twice the paper size enough to print data. After the end of printing, the print control apparatus cuts the sheet in half, generating an output material at higher speed than in printing on a sheet of the paper size.

According to the prior art, however, when an image forming apparatus receives a new job during the print process and has to interrupt a job in process and execute the print process for the new job, it temporarily suspends the preceding job to execute the print process of the succeeding job. Upon completion of the print process of the succeeding job, the image forming apparatus resumes the suspended preceding job. The process of the preceding job may delay by the time to suspend its process for the process of the succeeding job.

In this example of the print process, the operator may do work to exchange printing medium for a succeeding job or take out printed sheets from the delivery portion when suspending the preceding job to execute the succeeding job. The image forming apparatus stops to process the succeeding job, and the stop time of the image forming apparatus becomes longer.

Even the technique according to Japanese Patent Laid-Open No. 11-212750 cannot complete a preceding job at the scheduled end time because of the time delay when an interrupt job occurs. For example, the configuration in Japanese Patent Laid-Open No. 11-212750 can complete the print process within about half the necessary print process time of 1 h. For example, when the print process of a preceding job starts at 12:00, the scheduled end time is about 12:30. If an interrupt job occurs, the end time of the preceding job delays by the process time of the interrupt job. As a result, the technique described in Japanese Patent Laid-Open No. 11-212750 may delay the end time of the preceding job when a job interrupt occurs.

### SUMMARY OF THE INVENTION

The present invention has been made to overcome the conventional drawbacks, and has its object to implement an efficient print process by executing the print process of an interrupt job while maintaining the print process of a preceding job even when the interrupt job occurs.

According to one aspect of the present invention, an image forming apparatus which prints an image on a printing medium on the basis of a job associated with printing, comprising:

discrimination means for, when a second job to be processed by interrupting a first job is input, discriminating a blank area where a first image based on the first job is not laid out on a printing medium;

determination means for determining whether a second image based on the second job can be laid out in the blank area of the printing medium discriminated by the discrimination means; and

print control means for controlling printing so as to form the first image and the second image on the printing medium when the determination means determines that the second image can be laid out in the blank area on the printing medium.

In a preferred embodiment, the discrimination means discriminates the blank area when print priority added to the second job input during a process of the first job is higher than print priority added to the first job.

In a preferred embodiment, the apparatus further comprises cutting means for cutting a printing medium at a designated cutting position,

wherein when the determination means determines that the second image cannot be laid out in the blank area on the printing medium, the print control means controls printing of the first job and the second job so as to print on different printing medium, and

the cutting means cuts a medium printed by each job at a cutting position designated by the job.

In a preferred embodiment, the apparatus further comprises:

storage means for storing information on printing medium of a plurality of sizes in the image forming apparatus; and

selection means for, when the determination means determines that the second image cannot be laid out in the blank area on the printing medium, selecting a printing medium capable of laying out the first image and the second image from printing medium stored in the image forming apparatus on the basis of printing medium information stored in the storage means,

wherein the print control means controls printing so as to form the first image and the second image on the printing medium selected by the selection means.

In a preferred embodiment, the apparatus further comprises a plurality of discharge means for discharging printing medium having undergone a print process,

wherein the print control means controls to discharge printing medium on which the first image and the second image are printed to discharge means designated among the plurality of discharge means.

In a preferred embodiment, the plurality of discharge means include at least first discharge means mounted and exposed outside a housing, and second discharge means incorporated in the housing, and the print control means discharges printing medium on which the first image and the second image are printed to the first discharge means among the plurality of discharge means.

In a preferred embodiment, the print control means controls to discharge printing medium on which the first image and the second image are printed to first discharge means among the plurality of discharge means, and discharge printing medium on which the first image is only printed to second discharge means different from the first discharge means.

In a preferred embodiment, when a setting content of a print setting item designated in print setting information is different between the first job and the second job, the print control means controls printing so as to print the first image and the second image on different printing medium.

In a preferred embodiment, the print setting item includes at least one of a type and size of a printing medium, and a print mode.

According to another aspect of the present invention, a method of controlling an image forming apparatus which prints an image on a printing medium on the basis of a job associated with printing, comprising:

a discrimination step of, when a second job to be processed by interrupting a first job is input, discriminating a blank area where a first image based on the first job is not laid out on a printing medium;

a determination step of determining whether a second image based on the second job can be laid out in the blank area of the printing medium discriminated in the discrimination step; and

a print control step of controlling printing so as to form the first image and the second image on the printing medium when the second image is determined in the determination step to be able to be laid out in the blank area on the printing medium.

According to still another aspect of the present invention, a computer program which is stored in a computer-readable medium and causes a computer to control an image forming apparatus that prints an image on a printing medium on the basis of a job associated with printing is provided. The computer program causes the computer to execute

a discrimination step of, when a second job to be processed by interrupting a first job is input, discriminating a blank area where a first image based on the first job is not laid out on a printing medium,

a determination step of determining whether a second image based on the second job can be laid out in the blank area of the printing medium discriminated in the discrimination step, and

a print control step of controlling printing so as to form the first image and the second image on the printing medium when the second image is determined in the determination step to be able to be laid out in the blank area on the printing medium.

According to still yet another aspect of the present invention, an image forming apparatus which prints an image on a printing medium on the basis of a job associated with printing, comprising:

storage means for storing information on printing medium of a plurality of sizes in the image forming apparatus;

selection means for, when a second job to be processed by interrupting a first job is input, selecting a printing medium capable of laying out a first image based on the first job and a second image based on the second job on the basis of the printing medium information stored in the storage means; and

print control means for executing a print process based on the first image and the second image on the printing medium selected by the selection means.

According to yet still another aspect of the present invention, a method of controlling an image forming apparatus which prints an image on a printing medium on the basis of a job associated with printing, comprising:

a selection step of, when a second job to be processed by interrupting a first job is input, selecting a printing medium capable of laying out a first image based on the first job and a second image based on the second job on the basis of information stored in a storage medium and indicating printing medium of a plurality of sizes in the image forming apparatus; and

a print control step of executing a print process based on the first image and the second image on the printing medium selected in the selection step.

According to still yet another aspect of the present invention, a computer program which is stored in a computer-readable medium and causes a computer to control an image forming apparatus that prints an image on a printing medium on the basis of a job associated with printing, is provided. The computer program causes the computer to execute

a selection step of, when a second job to be processed by interrupting a first job is input, selecting a printing medium capable of laying out a first image based on the first job and a second image based on the second job on the basis of information stored in a storage medium and indicating printing medium of a plurality of sizes in the image forming apparatus, and

a print control step of executing a print process based on the first image and the second image on the printing medium selected in the selection step.

Further features of the present invention will be apparent from the following description of exemplary embodiments with reference to the attached drawings.

### BRIEF DESCRIPTION OF THE DRAWINGS

FIG. 1 is a view showing the configuration of an overall image processing system according to the first embodiment of the present invention;

FIG. 2 is a block diagram showing the arrangement of an image editing apparatus according to the first embodiment of the present invention;

FIG. 3 is a sectional view showing the structure of an image forming apparatus according to the first embodiment of the present invention;

FIG. 4 is a block diagram showing the arrangement of the main controller of the image forming apparatus according to the first embodiment of the present invention;

FIG. 5 is a sectional view showing the structure of a finisher attachable to the image forming apparatus according to the first embodiment of the present invention;

FIG. 6 is a sectional view showing the structure of a large-volume stacker attachable to the image forming apparatus according to the first embodiment of the present invention;

FIG. 7 is a schematic view showing the operation window of application software which runs on the image editing apparatus and has an image editing function according to the first embodiment of the present invention;

FIG. 8 is a schematic view showing the operation window of printer driver software running on the image editing apparatus according to the first embodiment of the present invention;

FIG. 9 is a schematic view showing an outline of job monitoring software running on a job monitoring apparatus according to the first embodiment of the present invention;

FIG. 10 is a view showing an example of detecting a portion (blank area) where the image forming apparatus does not print data of a job on a print sheet according to the first embodiment of the present invention;

FIG. 11 is a view showing an example of detecting a portion (blank area) where the image forming apparatus does not print data of a job on a print sheet according to the first embodiment of the present invention;

FIG. 12 is a view for explaining a print position when the image forming apparatus prints an image held in advance by an image forming apparatus 1002 in the blank area of a print sheet described with reference to FIGS. 10 and 11 according to the first embodiment of the present invention;

FIG. 13 is a view showing the relationship between the print sheet and the image position when the image forming apparatus 1002 prints the first image based on the first job processed in advance, and the second image based on the second job different from the first job according to the first embodiment of the present invention;

FIG. 14 is a view showing an outline of a job queue for managing jobs when the image forming apparatus receives a plurality of jobs according to the first embodiment of the present invention;

FIG. 15 is a view showing the output result of a job when the image forming apparatus receives the second job of high print priority during printing of the first job according to the first embodiment of the present invention;

FIG. 16 is a flowchart showing the print control process of the image forming apparatus according to the first embodiment of the present invention;

FIG. 17 is a view showing the output result of a job when an image forming apparatus receives the second job of high print priority during printing of the first job according to the second embodiment of the present invention;

FIG. 18 is a flowchart showing the print control process of the image forming apparatus according to the second embodiment of the present invention;

FIG. 19 is a view showing the structure of a printed sheet delivery section according to the third embodiment of the present invention;

FIG. 20 is a flowchart showing the print control process of an image forming apparatus according to the third embodiment of the present invention;

FIG. 21 is a view showing the structure of a printed sheet delivery section according to the fourth embodiment of the present invention;

FIG. 22 is a flowchart showing the print control process of an image forming apparatus according to the fourth embodiment of the present invention; and

FIG. 23 is a table showing an example of printing medium information held by the image forming apparatus according to the present invention.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

The present invention relates to an image forming system capable of executing an image forming process including a plurality of steps.

The present invention will describe particularly a configuration of efficiently executing image formation and print control when receiving a plurality of jobs (e.g., print jobs: to be simply referred to as jobs hereinafter) by an image forming apparatus which receives and prints image data edited by an image editing apparatus.

The present invention will also describe a configuration of efficiently executing image formation and print control when the image forming apparatus receives a job with print priority.

Further, the present invention will describe a configuration of efficiently processing a job in an environment where a job of many pages is printed, like a print process in a commercial printing market.

More specifically, based on a job attribute described in setting information (e.g., job ticket (JT)), a high-priority succeeding job (interrupt job) is composited and printed in a blank area of a sheet on which a job (preceding job) during the print process is printed. The print process can continue without decreasing the throughput of the preceding job. Composition printing is also called gang printing. Examples of the job attribute are the finish size, the output paper size, and the type of post-process.

### First Embodiment

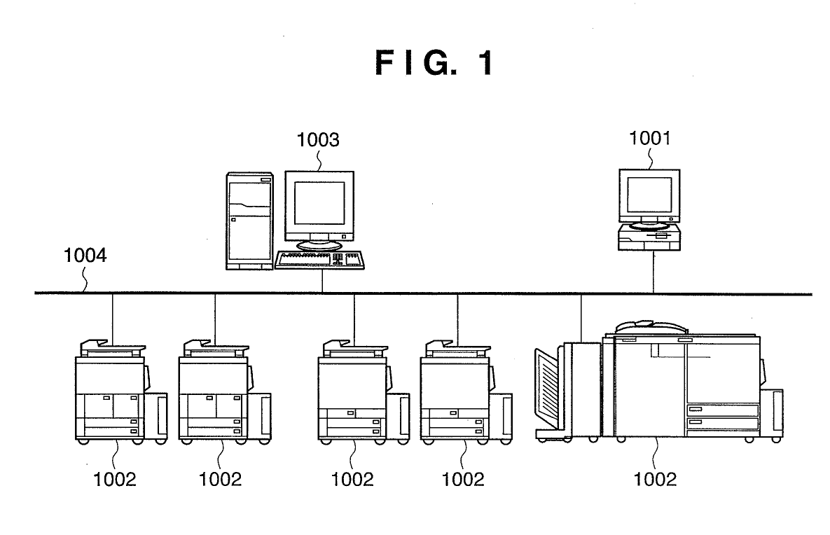

FIG. 1 is a view showing the configuration of an overall image processing system according to the first embodiment of the present invention.

Reference numeral 1001 denotes an image editing apparatus applied to the present invention. The image editing apparatus 1001 is generally a computer with a central processing unit.

Reference numeral 1002 denotes each image forming apparatus applied to the present invention. The image forming apparatuses 1002 take various forms such as a monochrome print-only apparatus, color outputtable apparatus, and large-volume outputtable apparatus.

Reference numeral 1003 denotes a job monitoring apparatus applied to the present invention. The job monitoring apparatus 1003 allows an operation to, for example, monitor a job input to the image forming apparatus 1002 or change the job priority.

Reference numeral 1004 denotes a network for connecting the image editing apparatus 1001, image forming apparatuses 1002, and job monitoring apparatus 1003 to each other.

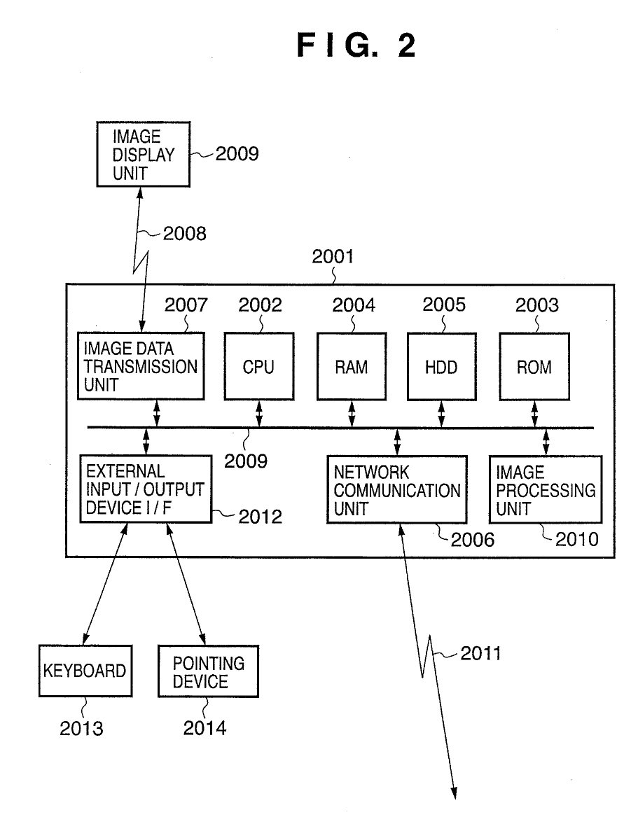

The arrangement of the image editing apparatus 1001 will be explained with reference to FIG. 2.

FIG. 2 is a block diagram showing the arrangement of the image editing apparatus according to the first embodiment of the present invention.

Reference numeral 2001 denotes a controller of the image editing apparatus 1001. Reference numeral 2002 denotes a CPU for running a program to control the whole image editing apparatus 1001. Reference numeral 2003 denotes a ROM which stores various programs for starting up the image editing apparatus 1001.

Reference numeral 2004 denotes a RAM functioning as a data work area and temporary save area for running a program to control the image editing apparatus 1001. Reference numeral 2005 denotes a hard disk drive (HDD) serving as a secondary storage device for storing program data expanded in the RAM 2004 to run, an application software program, and data necessary for the application software.

Reference numeral 2006 denotes a network communication unit which inputs/outputs data to/from the image forming apparatus 1002. Reference numeral 2007 denotes an image data transmission unit which transmits image data formed on the image editing apparatus 1001 to an image display unit 2009.

Reference numeral 2008 denotes a cable for transmitting image data from the image data transmission unit 2007 to the external image display unit 2009. The image display unit 2009 displays image data received from the image data transmission unit 2007.

Reference numeral 2010 denotes an image processing unit for performing various image processes for data (e.g., bitmap image data) received from the network communication unit 2006. The image processing unit 2010 has a composition function of compositing bitmap image data of two print sheet pages into bitmap image data of one page, and a removal function of removing an invalid drawing part from bitmap image data. The image processing unit 2010 has a correction function of correcting the print position when it is determined that bitmap image data skews from the reference direction. In this manner, the image processing unit 2010 has various image process functions of digitally editing bitmap image data.

Reference numeral 2011 denotes a network cable for receiving image data from an external apparatus and transmitting print data to the external apparatus. The network cable 2011 is connected to the network communication unit 2006. Reference numeral 2012 denotes an external input/output device I/F serving as an interface with an external input/output device. The external input/output device I/F 2012 connects, for example, a keyboard 2013 and pointing device 2014.

The job monitoring apparatus 1003 also has the same hardware configuration as that of the image editing apparatus 1001.

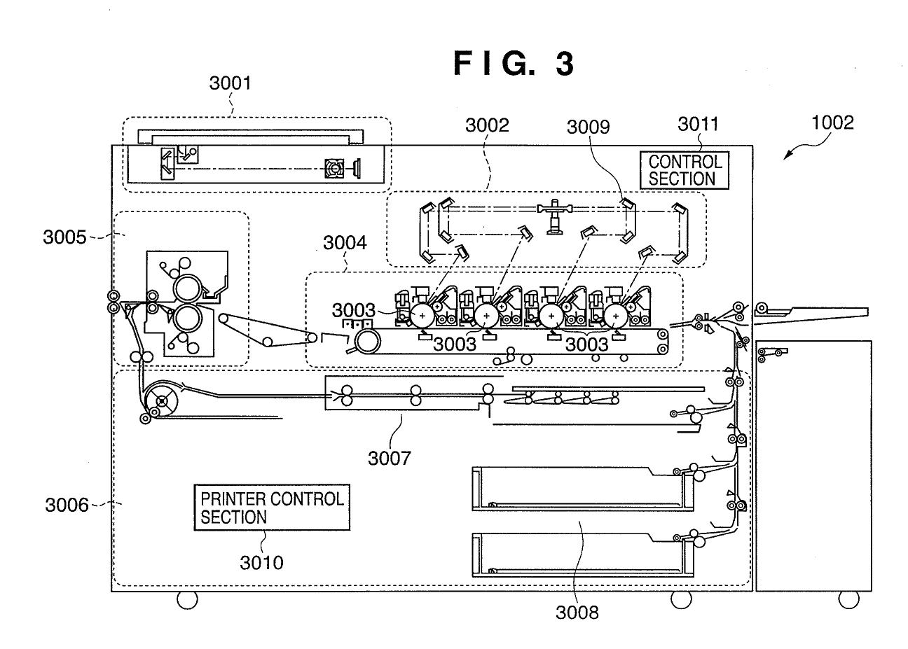

The structure of the image forming apparatus 1002 will be explained with reference to FIG. 3.

FIG. 3 is a sectional view showing the structure of the image forming apparatus according to the first embodiment of the present invention.

The image forming apparatus 1002 mainly comprises a scanner section 3001, a laser exposure section 3002, an image forming section 3004, a fixing section 3005, a sheet feed/conveyance section 3006, and a printer control section 3010 which controls these sections.

The scanner section 3001 illuminates a document on a document table, optically scans the document image, and converts the image into an electrical signal to create image data. The laser exposure section 3002 emits a light ray such as a laser beam modulated in accordance with the image data to a rotary polygon mirror 3009 which rotates at an equiangular velocity. Then, the laser exposure section 3002 irradiates a photosensitive drum 3003 with the light ray as reflected scanning light.

The image forming section 3004 has four developing units (developing stations) for a series of electrophotographic processes. The series of electrophotographic processes includes processes to drive the photosensitive drum 3003 to rotate, charge it by a charger, and develop a latent image formed on the photosensitive drum 3003 with toner by the laser exposure section 3002. The series of electrophotographic processes also includes processes to transfer the toner image onto a print sheet (also called a sheet), and recover a small amount of toner which is not transferred and remains on the photosensitive drum 3003.

The four developing units are arranged in the order of cyan (C), magenta (M), yellow (Y), and black (K). The magenta, yellow, and black developing units sequentially execute the image forming operation a predetermined time after the start of forming an image by the cyan developing unit. Under this timing control, a full-color toner image free from any color misregistration is transferred onto a sheet.

The fixing section 3005 comprises a combination of rollers and belts. The fixing section 3005 incorporates a heat source such as a halogen heater, and fuses and fixes by heat and pressure the toner on the sheet on which the toner image is transferred by the image forming section 3004.

The sheet feed/conveyance section 3006 has at least one sheet stocker 3008 typified by a sheet cassette or paper deck. The sheet feed/conveyance section 3006 separates one of sheets in the sheet stocker 3008 in accordance with an instruction from the printer control section 3010, and conveys the sheet to the image forming section 3004 and fixing section 3005. The developing stations transfer toner images of corresponding colors onto the conveyed sheet, finally forming a full-color toner image on the sheet. When forming images on the two surfaces of a sheet, a sheet having passed through the fixing section 3005 is controlled to pass through a double-sided conveyance path 3007 extending to the image forming section 3004.

The printer control section 3010 communicates with a control section 3011 for controlling the whole image forming apparatus 1002, and executes control in accordance with an instruction from the control section 3011. While managing the statuses of the scanner section 3001, laser exposure section 3002, image forming section 3004, fixing section 3005, and sheet feed/conveyance section 3006, the printer control section 3010 instructs them to keep the balance and operate smoothly.

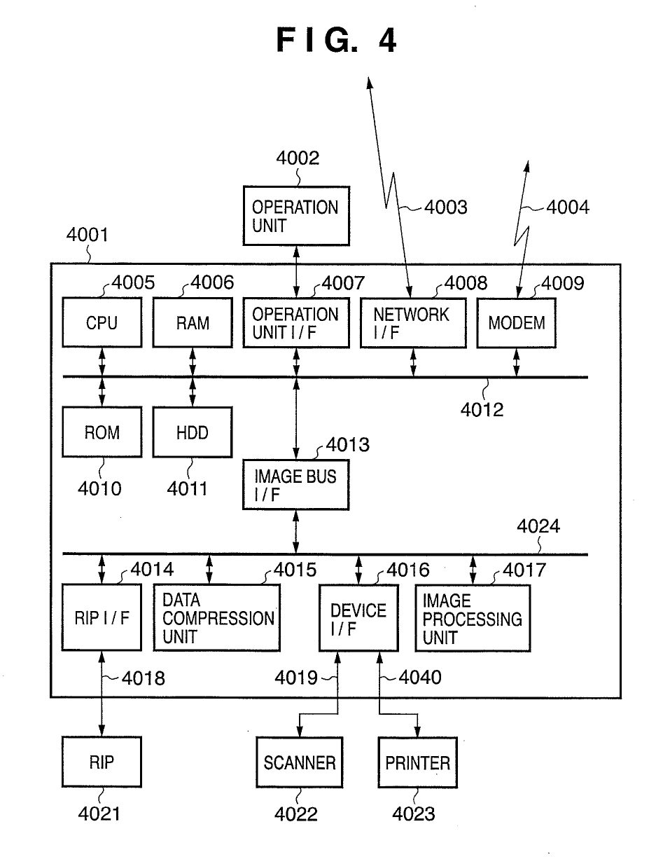

The main controller (control section 3011) of the image forming apparatus 1002 will be explained with reference to FIG. 4.

FIG. 4 is a block diagram showing the arrangement of the main controller of the image forming apparatus according to the first embodiment of the present invention.

Reference numeral 4001 denotes a main controller of the image forming apparatus 1002. Reference numeral 4002 denotes an operation unit for operating the image forming apparatus 1002. The operation unit 4002 is, e.g., a touch panel formed from a display and input unit. Reference numeral 4003 denotes a network cable for connecting an external device to a network.

Reference numeral 4004 denotes a line cable for connecting an external device to a telephone line. Reference numeral 4005 denotes a CPU for running a program to control the whole main controller 4001. Reference numeral 4006 denotes a RAM managed by a program running on the CPU 4005. The RAM 4006 is used as, e.g., a reception buffer for temporarily buffering externally received data, and an image data buffer for temporarily buffering image data rasterized by a raster image processor (RIP) 4021.

Reference numeral 4007 denotes an operation unit interface (I/F) for connecting the operation unit 4002 to the main controller 4001. Reference numeral 4008 denotes a network interface (I/F) for connecting the main controller 4001 to a network. Reference numeral 4009 denotes a modem for connecting the main controller 4001 to a telephone line.

Reference numeral 4010 denotes a ROM for storing data, programs running on the CPU 4005, and the like. Reference numeral 4011 denotes a hard disk drive (HDD) serving as a nonvolatile storage device capable of saving various data for a long time. Reference numeral 4012 denotes a CPU bus. Reference numeral 4024 denotes an image bus connected to hardware units for processing an image.

Reference numeral 4013 denotes an image bus interface (I/F) for connecting the CPU bus 4012 to the image bus 4024. The RIP 4021 has a function of converting externally input image description data into bitmap image data.

Reference numeral 4014 denotes a RIP interface (I/F) for connecting the RIP 4021 to the image bus 4024 via an image transfer bus 4018. Reference numeral 4015 denotes a data compression unit for compressing data. Reference numeral 4022 denotes a scanner corresponding to the scanner section 3001 in FIG. 3. Reference numeral 4023 denotes a printer corresponding to the laser exposure section 3002, image forming section 3004, fixing section 3005, and sheet feed/conveyance section 3006 in FIG. 3.

Reference numeral 4016 denotes a device interface (I/F) for connecting the scanner 4022 and printer 4023 to the image bus 4024 via data buses 4019 and 4040, respectively.

Reference numeral 4017 denotes an image processing unit for performing various image processes for bitmap image data generated by the scanner 4022 and RIP 4021. The image processing unit 4017 has a composition function of compositing bitmap image data of two print sheet pages into bitmap image data of one page, and a removal function of removing an invalid drawing part generated by dust or the like mixed in scanning a document by the scanner 4022. The image processing unit 4017 has a correction function of correcting the print position when the scanner 4022 scans a document with skew. In this way, the image processing unit 4017 has various image process functions of digitally editing bitmap image data.

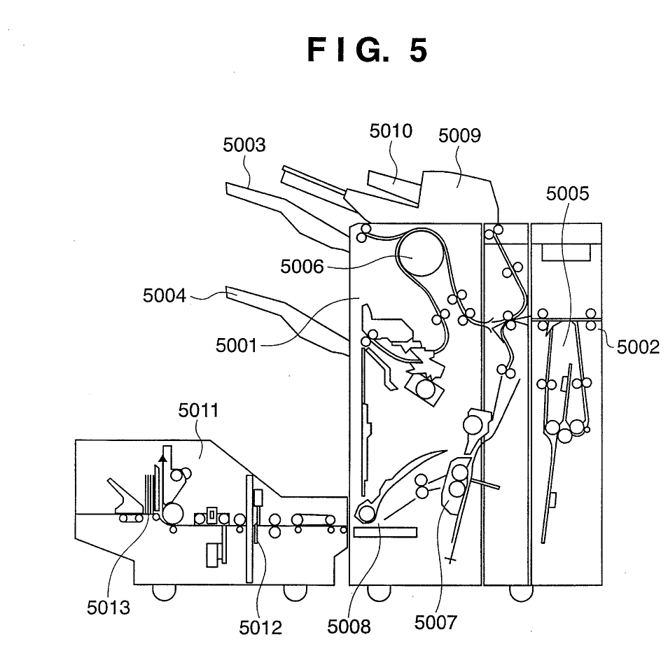

The structure of a finisher as an example of a post-processing apparatus attachable to the image forming apparatus 1002 will be explained with reference to FIG. 5.

FIG. 5 is a sectional view showing the structure of the finisher attachable to the image forming apparatus according to the first embodiment of the present invention.

A finisher 5001 performs various control operations such as the start, suspension, and end of a process in accordance with an instruction from the main controller 4001.

A sheet set in a sheet feed mechanism 5002 enters the finisher 5001 at the start of the process by the finisher 5001. The finisher 5001 comprises a sample tray 5003 and stack tray 5004. A sheet is discharged by switching between the sample tray 5003 and the stack tray 5004 in accordance with the job type and the number of discharged sheets.

The sample tray allows a check of a print result during printing. For example, when the user designates change of the discharge destination to the sample tray during printing, the print result discharge destination temporarily changes to the sample tray. The user checks a printed material discharged onto the sample tray to determine whether to continue printing or to stop it and change print data.

There are two typical sorting methods of sorting and discharging sheets. One is bin sorting of distributing sheets to respective discharge bins. The other is shift sorting of sorting sheets for each job using an electronic sorting function by shifting bins (or trays) to far and near sides in a direction in which the finisher 5001 delivers sheets.

The electronic sorting function is called collate. This is a function (collate function) of changing the buffered page order and discharge order when a large-capacity memory is mounted in the main controller 4001 and is usable as a buffer memory. The collate function can also support the electronic sorting function.

A grouping function is also available to sort sheets for each page, unlike the sorting function of sorting sheets for each job.

When the staple mode is set for a job to be output, it is controlled to discharge sheets onto the stack tray 5004. Before discharging sheets onto the stack tray 5004, sheets are sequentially accumulated for each job in the internal process tray of the finisher 5001, and bound by a stapler on the process tray. Then, the bound sheet bundle is discharged onto the stack tray 5004.

A Z-folding device 5005 for Z-folding a sheet, and a puncher 5006 for forming two (or three) holes for filing are arranged along the paths extending to the two trays, and execute their processes in accordance with the job type.

For example, when the user makes a Z-folding process setting via the operation unit 4002 as a setting associated with a sheet process for a job to be output, the Z-folding device 5005 folds sheets of the job. Then, the sheets pass through the finisher 5001 and are delivered onto a discharge tray such as the stack tray 5004 or sample tray 5003.

When the user makes a punching process setting via the operation unit 4002 as a setting associated with a sheet process for a job to be output, the puncher 5006 punches sheets of the job. Then, the sheets pass through the finisher 5001 and are delivered onto a discharge tray such as the stack tray 5004 or sample tray 5003.

A saddle stitcher 5007 performs a process (bookbinding process) of binding sheets at two center portions, clamping the center of the sheets by rollers, and folding the sheets in half to create a booklet like a brochure. Sheets bound by the saddle stitcher 5007 are discharged onto a booklet tray 5008. Whether to execute a sheet process operation such as the bookbinding process by the saddle stitcher 5007 is also based on a sheet process setting made by the user for a job to be output, as described above.

An inserter 5009 feeds a sheet on an insert tray 5010 to a discharge tray such as the stack tray 5004 or sample tray 5003 without feeding the sheet to the image forming apparatus 1002. The inserter 5009 can insert a sheet on it between sheets (discharged sheets printed by the image forming apparatus 1002) fed to the finisher 5001. The user sets sheets on the insert tray 5010 of the inserter 5009 while the sheets face up. Then, the sheets are sequentially fed from the top sheet by pickup rollers.

Sheets from the inserter 5009 are conveyed to the stack tray 5004 or sample tray 5003, and discharged while facing down. When feeding sheets to the saddle stitcher 5007, they are fed to the puncher side once, switched back, and fed to the saddle stitcher 5007 to adjust the facing sides of the sheets. Whether to execute a sheet process operation such as the sheet insertion process by the inserter 5009 is also based on a sheet process setting made by the user for a job to be output, as described above.

A trimmer 5011 (cutting device) will be explained.

A (saddle-stitched) booklet output from the saddle stitcher 5007 enters the trimmer 5011. The booklet output is fed by rollers by a predetermined length, and cut by a cutter 5012 by a predetermined length, finely aligning uneven edges of pages of the booklet. The cut booklet is held in a booklet holding unit 5013. Whether to execute a sheet process operation such as the cutting process by the trimmer 5011 is also based on a sheet process setting made by the user for a job to be output, as described above.

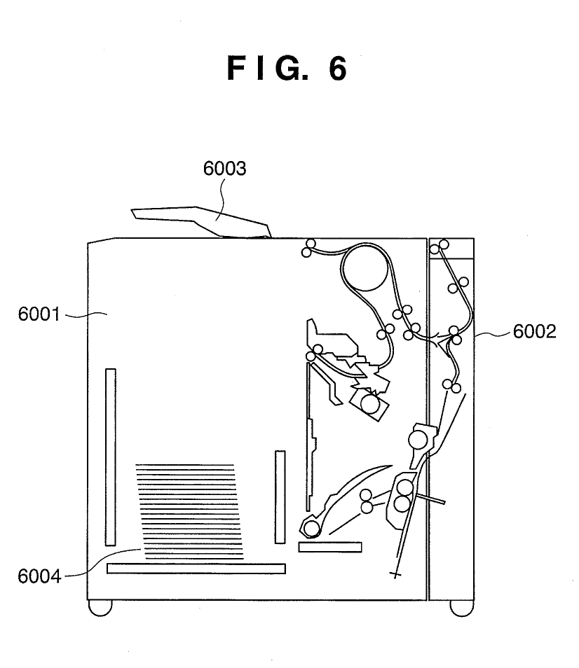

The structure of a large-volume stacker as an example of a post-processing apparatus attachable to the image forming apparatus 1002 will be explained with reference to FIG. 6.

FIG. 6 is a sectional view showing the structure of the large-volume stacker attachable to the image forming apparatus according to the first embodiment of the present invention.

A large-volume stacker 6001 controls, for example, the start, suspension, and end of a process in accordance with an instruction from the main controller 4001.

A sheet set in a sheet feed mechanism 6002 enters the large-volume stacker 6001 at the start of the process by the large-volume stacker 6001. The large-volume stacker 6001 comprises a sample tray 6003 and stack tray 6004, which are switched in accordance with the job type and the number of discharged sheets.

The stack tray 6004 inhibits takeout of delivered sheets during delivery to the stack tray 6004. To take out printed sheets from the stack tray 6004, output to the stack tray 6004 must be suspended.

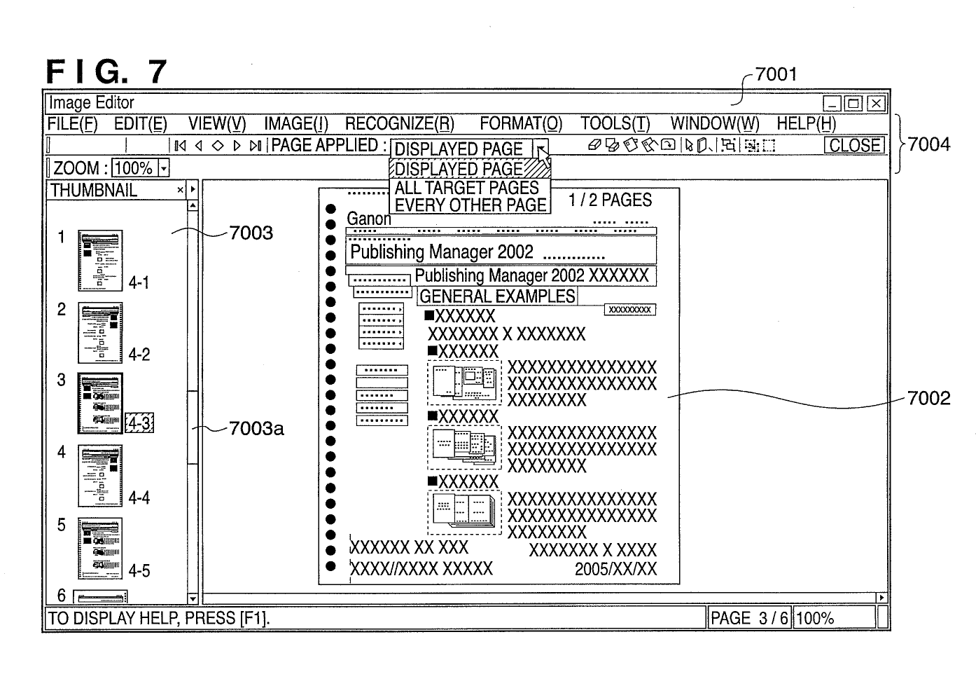

The operation window of application software which runs on the image editing apparatus 1001 and has an image editing function will be explained with reference to FIG. 7.

FIG. 7 is a schematic view showing the operation window of application software which runs on the image editing apparatus and has the image editing function according to the first embodiment of the present invention.

Reference numeral 7001 denotes an operation window generated by application software with the image editing function. Reference numeral 7002 denotes an image editing area. An operator who edits an image can designate various image editing processes for an image in the image editing area 7002. The operator can designate the process contents of the image editing process with various controls 7004 (menus, buttons, and the like).

Reference numeral 7003 denotes a thumbnail display portion which displays the thumbnail image of a page created by application software. The thumbnail display portion 7003 allows browsing the thumbnail images of all pages of a job by operating a scroll bar 7003a.

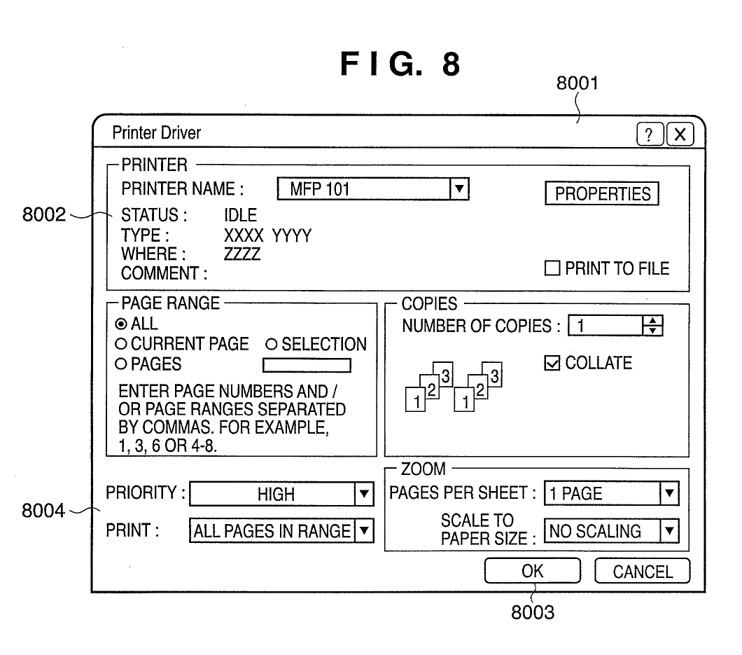

The operation window of printer driver software running on the image editing apparatus 1001 will be described with reference to FIG. 8.

FIG. 8 is a schematic view showing the operation window of the printer driver software running on the image editing apparatus according to the first embodiment of the present invention.

Reference numeral 8001 denotes an operation window generated by printer driver software.

When an image processed by application software running on the image editing apparatus 1001 is to be transmitted as a job to the image forming apparatus 1002, the operator can make various print settings associated with the job via the operation window 8001.

Reference numeral 8002 denotes a setting area for making various settings of a job. The operator can make various print settings such as the number of print pages of a document to be printed and the number of copies in the setting area 8002. Further, the operation window 8001 shifts to advanced setup windows to allow the operator to make settings such as the paper type (printing medium type), imposition layout, and color image processing method.

Reference numeral 8003 denotes a button for designating sending (printing) of a job. The operator can send (print) a job to the image forming apparatus 1002 by pressing the button 8003.

Reference numeral 8004 denotes a text box for designating the print priority of a job. An operator who designates printing of an image on the image editing apparatus 1001 can designate the priority of the print process in the text box 8004 for designating the priority. The text box 8004 may also allow the operator to designate merely an interrupt attribute for interrupting a preceding job and executing the print process. The image forming apparatus 1002 controls the print order of jobs received in accordance with the print priority.

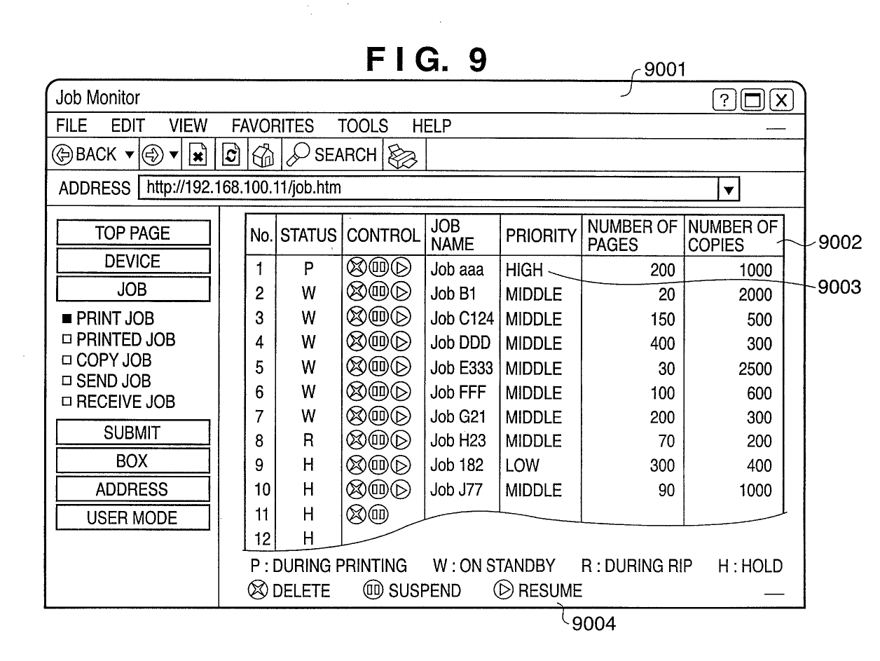

Job monitoring software running on the job monitoring apparatus 1003 will be described with reference to FIG. 9.

FIG. 9 is a schematic view showing an outline of the job monitoring software running on the job monitoring apparatus according to the first embodiment of the present invention.

An operation window 9001 generated by the job monitoring software can display the job status in the image forming apparatus 1002, and can issue various instructions such as deletion and suspension of a job and resume of a suspended job.

Reference numeral 9002 denotes a list display portion of jobs running on the image forming apparatus 1002. When the image forming apparatus 1002 receives a job, the list display portion 9002 displays the job. A process-ended job is deleted from the list display portion 9002.

Reference numeral 9003 denotes a priority display portion representing the print priority of a job displayed at the list display portion 9002. The priority display portion 9003 displays priority information assigned to a job designated in the text box 8004 of the operation window 8001 in FIG. 8.

Reference numeral 9004 denotes an instruction portion for designating deletion or suspension of a job displayed at the list display portion 9002 or resume of a suspended job.

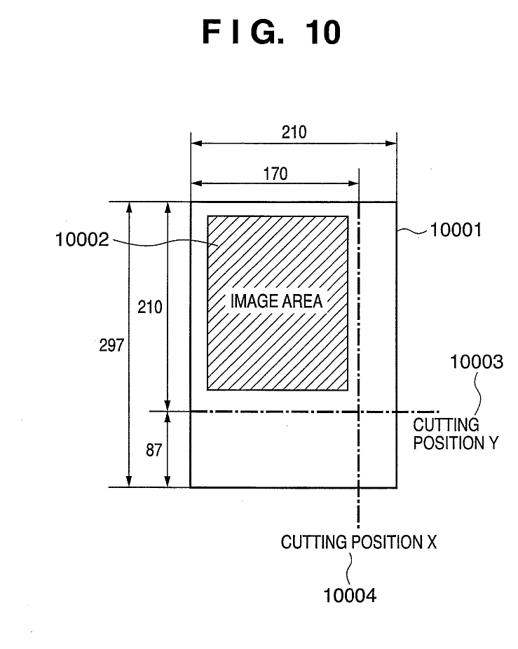

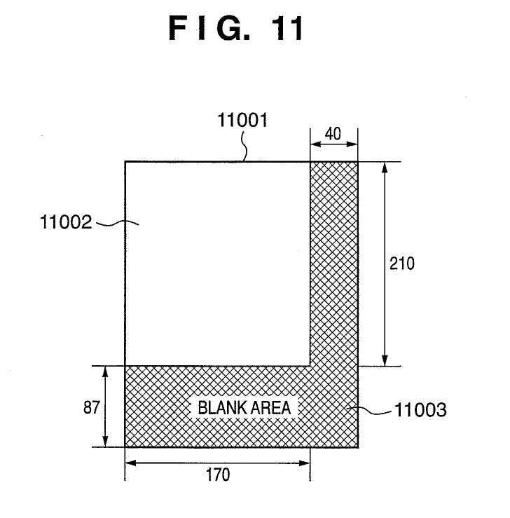

An example of a print data process will be explained with reference to FIGS. 10 and 11.

FIGS. 10 and 11 are views showing an example of detecting a portion (blank area) where the image forming apparatus does not print data of a preceding job on a print sheet according to the first embodiment of the present invention.

Reference numerals 10001 and 11001 denote print sheets. The first embodiment will exemplify a case in which the print job designates the print sheet 10001 which is 297 mm long and 210 mm wide. The image forming apparatus 1002 holds the vertical and horizontal sizes of each sheet type in the RAM 4006 or the like.

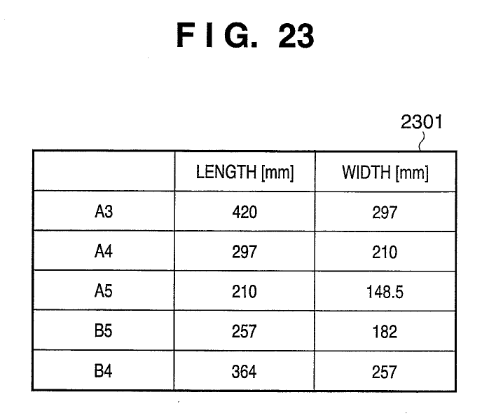

For example, the image forming apparatus 1002 holds pieces of information such as “an A4 sheet is 297 mm long and 210 mm wide.” and “an A5 sheet is 210 mm long and 148.5 mm wide.” From these pieces of information, the image forming apparatus can calculate a print sheet size even if the print job designates not a concrete size but “A4”, “A5”, or the like. That is, the image forming apparatus 1002 stores information as shown in FIG. 23 on printing medium of a plurality of sizes in the image forming apparatus. The image forming apparatus 1002 holds information (printing medium information 2301) on the print sheet size in FIG. 23, but may hold another information.

Reference numerals 10002 and 11002 denote image areas of a preceding job printed on the print sheet 10001. In this example, the vertical (longitudinal) size of the image areas 10002 and 11002 (FIG. 11) is 210 mm, and their horizontal (widthwise) size is 170 mm. The image area means an image printed on a print sheet by a preceding job, or an area containing both the image and a margin image ensured around the image.

FIGS. 10 and 11 assume a case in which no margin image is necessary, and a case in which a margin image is necessary. The image forming apparatus 1002 can calculate an image area size by analyzing a received job. More specifically, a job received by the image forming apparatus 1002 is described in a page description language interpretable by the image forming apparatus. The image forming apparatus 1002 can calculate the size of an image to be printed on the basis of a received job by analyzing the received page description language.

In the first embodiment, when printing an image falling within the image area 10002 on the print sheet 10001, the image is laid out using the upper left corner of the print sheet 10001 as an origin. The image is laid out so that the upper left corner of the print sheet 10001 and that of the image area 10002 (or that of a margin area ensured in the image forming apparatus 1002) coincide with each other.

Reference numerals 10003 and 10004 denote horizontal and vertical cutting positions to cut an unnecessary area of the print sheet 10001 after printing out the image in the image area 10002 on the print sheet 10001. After the image forming apparatus 1002 prints, a post-processing apparatus such as a finisher executes the cutting process in accordance with information on the cutting positions 10003 and 10004.

Reference numeral 11003 denotes a blank area generated as a result of laying out, on the print sheet 11001, print data of a print job to be processed.

The blank area 11003 is calculated from a size obtained by subtracting the vertical size of the image area 11002 from that of the print sheet 11001, and a size obtained by subtracting the horizontal size of the image area 11002 from that of the print sheet 11001. In the first embodiment, the blank area 11003 shown in FIG. 11 can be calculated (derived) from a vertical size of 87 mm (297-210 mm) and a horizontal size of 40 mm (210-170 mm) obtained by the above calculation method.

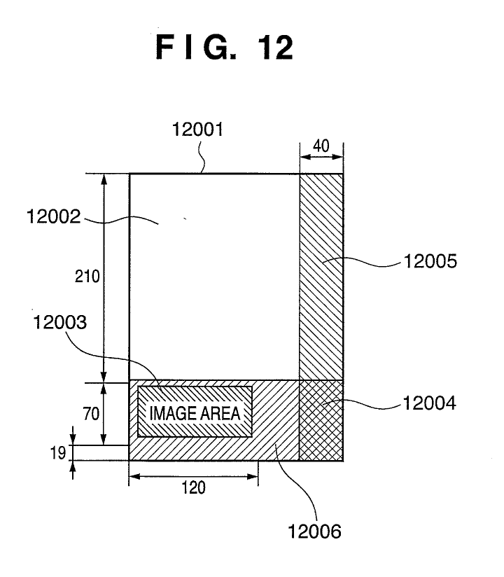

FIG. 12 is a view for explaining a print position when the image forming apparatus prints an image held in advance by the image forming apparatus 1002 in the blank area of a print sheet described with reference to FIGS. 10 and 11 according to the first embodiment of the present invention.

Reference numeral 12001 denotes a print sheet. The size of the print sheet 12001 complies with that of the print sheet described with reference to FIGS. 10 and 11. Reference numeral 12002 denotes a blank area where no print data of a preceding job is drawn. The size and layout of the area 12002 comply with those of the image area described with reference to FIGS. 10 and 11.

Reference numeral 12003 denotes an image drawn with print data of a job merged with a preceding job. The first embodiment exemplifies the image 12003 which is 70 mm long and 120 mm wide.

Reference numeral 12004 denotes a blank area common to the right and lower blank areas of the print sheet 12001.

Reference numeral 12005 denotes part of the right blank area of the print sheet 12001. The right blank area of the print sheet 12001 is a combined area (to be referred to as a right blank area hereinafter) of the blank areas 12005 and 12004.

Reference numeral 12006 denotes part of the lower blank area of the print sheet 12001. The lower blank area of the print sheet 12001 is a combined area (to be referred to as a lower blank area hereinafter) of the blank areas 12006 and 12004.

When laying out the image 12003 in the blank areas 12004, 12005, and 12006, the vertical size of the image 12003 is compared with those of the right and lower blank areas, and the horizontal size of the image 12003 is compared with those of the right and lower blank areas. If it is determined from the comparison results that the size of the image 12003 is smaller than that of the right or lower blank area, the image position of the image 12003 is determined so as to lie in the blank area.

In FIG. 12, the horizontal size of the image 12003 is larger than that of the right blank area, so it is determined that the image 12003 cannot be laid out in the right blank area. However, the horizontal size (120 mm) and vertical size (70 mm) of the image 12003 are smaller than the horizontal size (170 mm) and vertical size (87 mm) of the lower blank area. Thus, the image forming apparatus 1002 determines that the image 12003 can be laid out in the lower blank area.

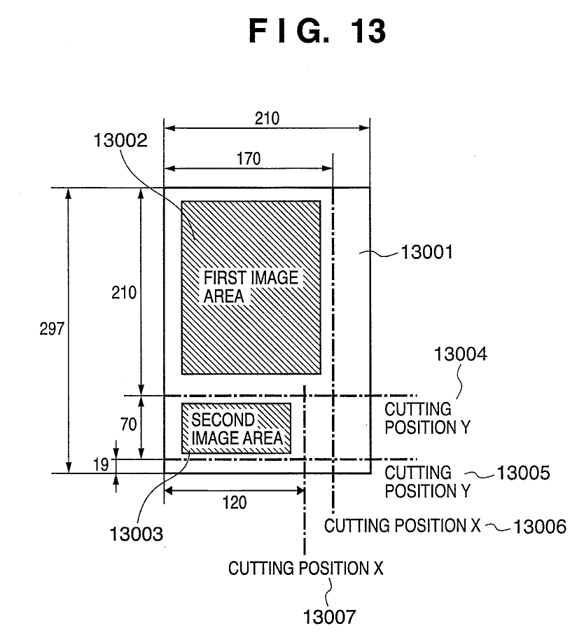

FIG. 13 is a view showing the relationship between the print sheet and the image position when the image forming apparatus 1002 prints the first image based on the first job processed in advance, and the second image based on the second job different from the first job according to the first embodiment of the present invention.

Reference numeral 13001 denotes a print sheet. The size of the print sheet 13001 complies with that of the print sheet described with reference to FIGS. 10 to 12.

Reference numeral 13002 denotes a first image area based on the first preceding job. The size and layout of the first image area 13002 comply with those of the image area described with reference to FIGS. 10 and 11.

Reference numeral 13003 denotes a second image area based on the second job different from the first job. The size and layout of the second image area 13003 comply with those of the image area described with reference to FIG. 12.

Reference numerals 13004 and 13006 denote horizontal and vertical cutting positions to cut part of a print sheet to form the final printed material of the first job.

Reference numerals 13005 and 13007 denote horizontal and vertical cutting positions to cut part of a sheet to form the final printed material of the second job.

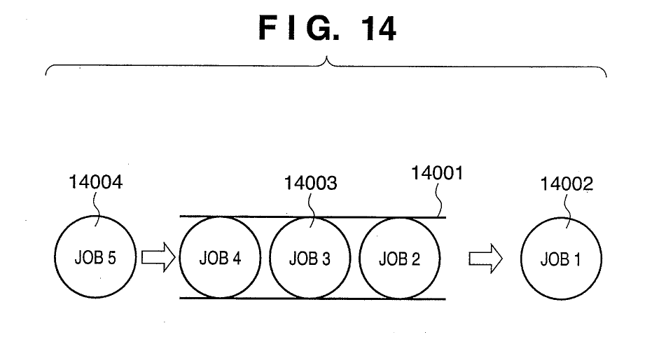

FIG. 14 is a view showing an outline of a job queue for managing jobs when the image forming apparatus receives a plurality of jobs according to the first embodiment of the present invention.

Reference numeral 14001 denotes a job queue. When receiving a job from an external device (e.g., image editing apparatus 1001), the image forming apparatus 1002 stores the job in the job queue 14001. The job queue 14001 continues to hold the job until the image forming apparatus 1002 shifts to a printable state. The job queue 14001 is allocated in, for example, the RAM 4006 (FIG. 4).

Reference numerals 14002 to 14004 schematically denote jobs. The job 14002 is in the print state. The job 14003 stands by in the job queue 14001. The job 14004 is to be input from the external device to the image forming apparatus 1002.

The job queue 14001 has the FIFO structure, so jobs input to the image forming apparatus 1002 undergo the print process in accordance with the input order. The print priority level is identifiable as a job attribute, and when a job of high print priority is received, it is preferentially processed.

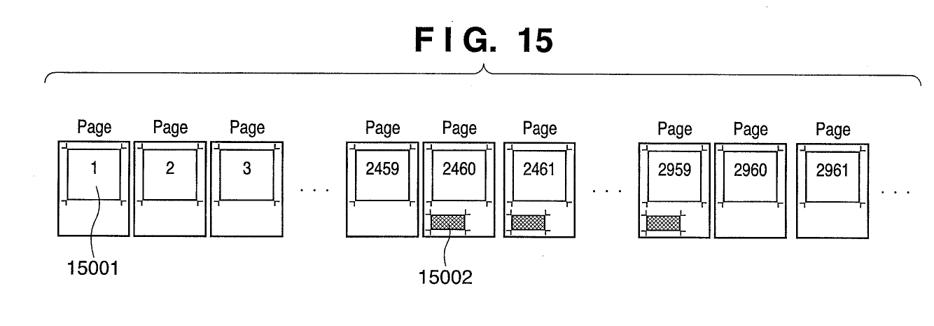

FIG. 15 is a view showing the output result of a job when the image forming apparatus receives the second job of high print priority during printing of the first job according to the first embodiment of the present invention.

Reference numeral 15001 denotes an image area subjected to printing by the first job processed in advance. Reference numeral 15002 denotes an image area subjected to printing by the second job of high priority input during the process of the first job. In FIG. 15, data of the second job are printed parallel to the 2460th to 2959th pages of the first job.

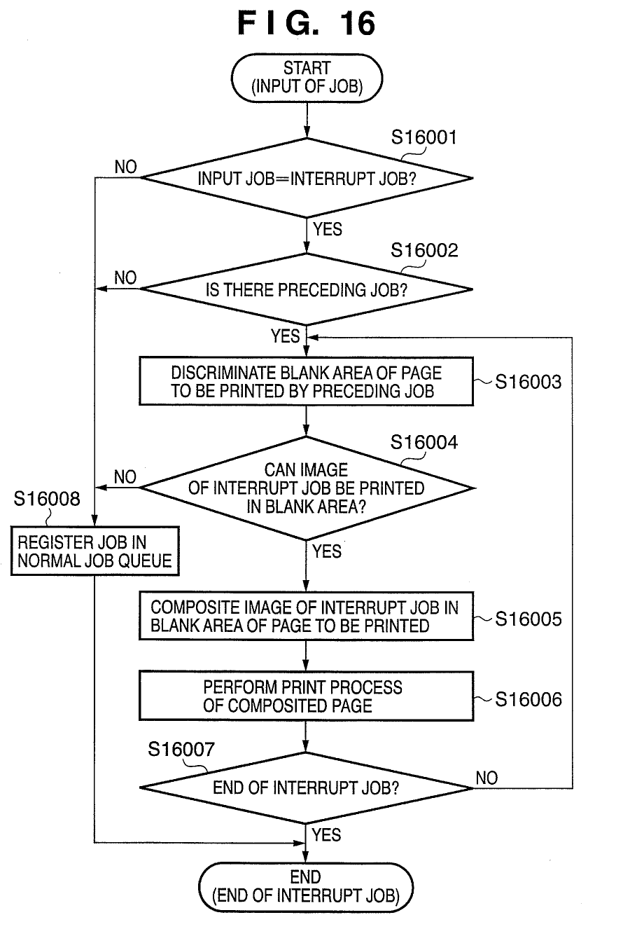

The print control process of the image forming apparatus 1002 according to the first embodiment will be explained with reference to FIG. 16.

FIG. 16 is a flowchart showing the print control process of the image forming apparatus according to the first embodiment of the present invention. The control section 3011 of the image forming apparatus executes each step in the flowchart.

The print control procedures of the image forming apparatus 1002 according to the first embodiment will be explained with reference to the flowchart of FIG. 16.

In step S16001, when receiving a job from an external device, the image forming apparatus 1002 determines whether the received job is a high-priority job (to be referred to as an interrupt job hereinafter). As described above, the job contains, as a job attribute, information to identify the print priority level. The image forming apparatus 1002 can determine a high-priority job by analyzing information contained in the job.

The image forming apparatus 1002 executes processes in steps S16003 and S16004 when the print priority added to an interrupt job input during the process of a preceding job is higher than that added to the preceding job. The interrupt job may contain an attribute indicating an interrupt to process the job.

If the received job is not an interrupt job (NO in step S16001), the process advances to step S16008. The image forming apparatus 1002 queues (registers) the received job in the job queue 14001 and ends the process. If the received job is an interrupt job (YES in step S16001), the process advances to step S16002.

In step S16002, the image forming apparatus 1002 determines whether there is a job (to be referred to as a preceding job hereinafter) during the print process, that is, whether there is the job 14002 shown in FIG. 14.

If there is no preceding job (NO in step S16002), the process advances to step S16008. The image forming apparatus 1002 queues the received job in the job queue 14001 and ends the process.

As for a job registered in the job queue 14001, the trimmer 5011 (FIG. 5) of the post-processing apparatus trims printed sheets as needed after printing of the job. For example, in the layout of FIG. 10, the trimmer 5011 trims sheets having undergone printing in the image area 10002 at the cutting positions 10003 and 10004. After trimming, the partially printed sheets containing the image area 10002 are discharged to a designated discharge portion, and the remaining partially printed sheets are discarded to a designated disposal portion.

If there is a preceding job (YES in step S16002), the process advances to step S16003. In step S16003, according to the method described with reference to FIGS. 10 and 11, the image forming apparatus 1002 discriminates the blank area of a page to be printed by the preceding job. That is, when receiving an interrupt job to be processed by interrupting the preceding job, the image forming apparatus 1002 discriminates a blank area where no preceding job-based image is laid out on a printing medium.

In step S16004, according to the method described with reference to FIG. 12, the image forming apparatus 1002 determines whether an image area subjected to printing by the interrupt job can be laid out in the blank area discriminated in step S16003. That is, the image forming apparatus 1002 determines whether an interrupt job-based image can be laid out in the blank area of the printed medium discriminated in step S16003.

If the image forming apparatus 1002 determines in step S16004 that an image area subjected to printing by the interrupt job cannot be laid out in the blank area discriminated in step S16003 (NO in step S16004), the process advances to step S16008. In step S16008, the image forming apparatus 1002 queues the received job in the job queue 14001 and ends the process.

If no image of the interrupt job can be laid out in the blank area, the image forming apparatus 1002 controls to print on different printing medium for the preceding and interrupt jobs in step S16008. After that, the cutting device cuts each print result at a position designated by each job. The cutting device may be attached to the image forming apparatus 1002 or may be independent of the image forming apparatus 1002.

If the image forming apparatus 1002 determines that an image area subjected to printing by the interrupt job can be laid out in the blank area discriminated in step S16003 (YES in step S16004), the process advances to step S16005.

In step S16005, the image forming apparatus 1002 uses the image processing unit 4017 with the image composition function to execute the image composition process of compositing the image of the interrupt job in the blank area discriminated in step S16003. In step S16006, the image forming apparatus 1002 executes the print process by transmitting, to the printer 4023, a page including the images of the preceding and interrupt jobs composited in step S16005.

More specifically, if the image forming apparatus 1002 determines in step S16004 that the image of the interrupt job can be laid out in the blank area on the printing medium, it controls printing to form the images of the preceding and interrupt jobs on the printing medium.

In step S16007, the image forming apparatus 1002 determines whether all target images of the interrupt job have been printed. If all target images of the interrupt job have been printed (YES in step S16007), the image forming apparatus 1002 ends the print process of the interrupt job and continues only the process of the preceding job. If not all target images of the interrupt job have been printed (NO in step S16007), the process returns to step S16003, and the image forming apparatus 1002 repetitively executes the process to print data of the interrupt job on an output print sheet of the preceding job.

As described above, according to the first embodiment, even when receiving a job of high print priority during the print process of a preceding job, the image forming apparatus can execute the print process of the high-priority job without decreasing the print throughput of the preceding job.

In this fashion, even when receiving a new job of high print priority during the print process, the image forming apparatus can execute the print process of the high-priority succeeding job while continuing the print process of the preceding job.

The first embodiment can avoid a conventional problem that the time necessary for the print process of a preceding job becomes longer when the image forming apparatus receives a new job of high print priority during the print process.

### Second Embodiment

The second embodiment will be explained with reference to FIGS. 1 to 16, 17, and 18. In the first embodiment, the image forming apparatus 1002 performs composition printing of preceding and interrupt jobs without changing the print sheet size used in output. In general, the image forming apparatus 1002 stores print sheets of a plurality of sizes in sheet stockers, and can properly select and use sheets. Even if composition printing of preceding and interrupt jobs is impossible on a print sheet used for a preceding job, it may become possible by changing the output print sheet to a larger size.

In this case, the print results of respective jobs can be obtained by cutting print sheets using a post-processing apparatus with the cutting function after composition printing on large-size print sheets. The post-processing apparatus may be attached to the printing apparatus or may be independent.

The second embodiment will describe this configuration.

Process procedures in FIGS. 1 to 16 comply with those described in the first embodiment.

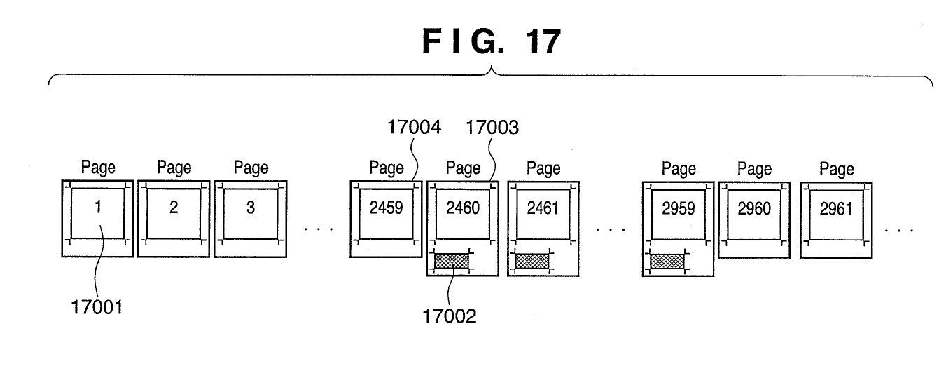

FIG. 17 is a view showing the output result of a job when an image forming apparatus receives the second job of high print priority during printing of the first job according to the second embodiment of the present invention.

Reference numeral 17001 denotes an image area subjected to printing by the first job processed in advance. Reference numeral 17002 denotes an image area subjected to printing by the second job of high priority input during the process of the first job.

In the second embodiment, the size of a print sheet 17003 on which composited images of the second and first jobs are printed is different from that of a print sheet 17004 on which the image of the first job before composition is printed. In FIG. 17, 500 pages of the second job are printed on the 2460th to 2959th pages of the first job.

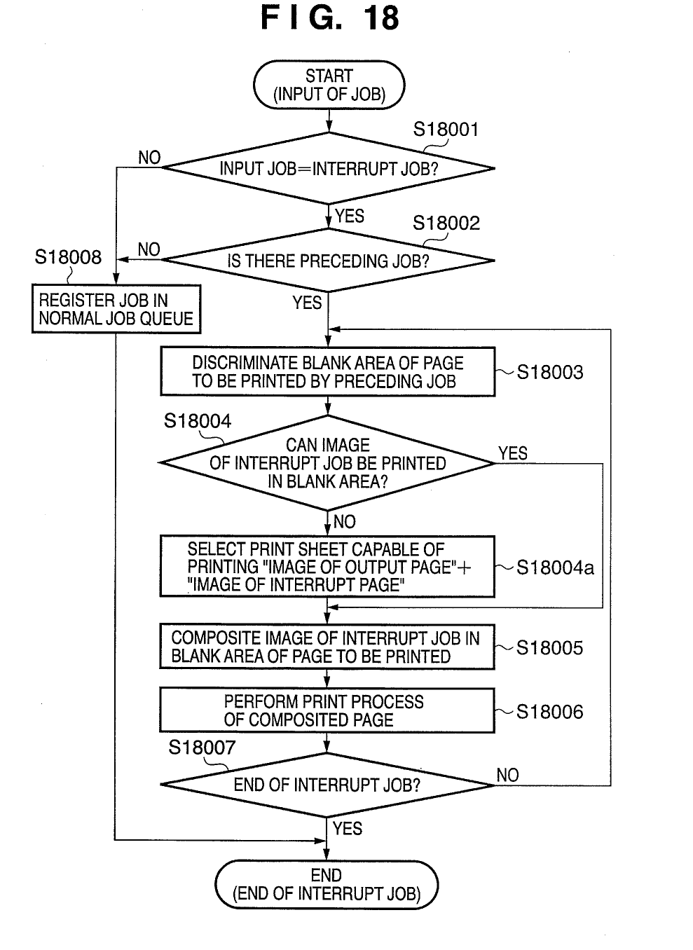

The print control process of an image forming apparatus 1002 according to the second embodiment will be explained with reference to FIG. 18.

FIG. 18 is a flowchart showing the print control process of the image forming apparatus according to the second embodiment of the present invention.

The print control procedures of the image forming apparatus 1002 according to the second embodiment will be explained with reference to the flowchart of FIG. 18.

Steps S18001 to S18004 and S18005 to S18008 in FIG. 18 correspond to steps S16001 to S16004 and S16005 to S16008 in FIG. 16 according to the first embodiment, and only the difference will be explained. In FIG. 18, a process in step S18004a is added to FIG. 16.

In step S18004, if the image forming apparatus 1002 determines that an image area subjected to printing by an interrupt job can be laid out in a blank area discriminated in step S18003 (YES in step S18004), the process advances to step S18005.

If the image forming apparatus 1002 determines that an image area subjected to printing by the interrupt job cannot be laid out in the blank area discriminated in step S18003 (NO in step S18004), the process advances to step S18004a.

In step S18004a, the image forming apparatus 1002 selects a print sheet capable of printing the images of the first and second jobs shown in FIG. 13. In other words, the image forming apparatus 1002 selects a print sheet of a size enough to contain the image areas of the images of the first and second jobs.

As described above, the image forming apparatus 1002 holds printing medium information on print sheets set in the image forming apparatus. The image forming apparatus 1002 calculates the sum of the size of a first job-based image and a second job-based image. The image forming apparatus 1002 selects a print sheet larger than the total size of the image area obtained by compositing the first and second jobs in step S18004a. If the sheet stocker in the image forming apparatus 1002 does not stock a print sheet of a selectable size, the first and second jobs are registered as different jobs in a job queue 14001 in step S18008.

In step S18005, the image forming apparatus 1002 uses an image processing unit 4017 with the image composition function to execute the image composition process to composite the images of the preceding and interrupt jobs. In step S18006, the image forming apparatus 1002 executes the print process by transmitting, to a printer 4023, the images of the preceding and interrupt jobs composited in step S18005. If the process in step S18004a is executed, the image forming apparatus 1002 executes the print process using the selected print sheet.

As described above, according to the second embodiment, when the image forming apparatus has print sheets of a plurality of sizes, it can execute composition printing of preceding and interrupt jobs as much as possible within the sizes of available print sheets. The image forming apparatus can execute the print process of a high-priority interrupt job without delaying a preceding job.

According to the second embodiment, if the image forming apparatus determines in step S18004 that no image of an interrupt job can be laid out in the blank area (NO in step S18004), it selects a print sheet capable of laying out the images of preceding and interrupt jobs. However, the process in step S18004a may be executed without performing the determination process in step S18004.

More specifically, if the image forming apparatus determines that an input job is an interrupt job, it calculates and adds a preceding job-based image size and interrupt job-based image size. The image forming apparatus selects a sheet capable of laying out a preceding job-based image and interrupt job-based image.

### Third Embodiment

The third embodiment will be explained with reference to FIGS. 1 to 16, 19, and 20.

Process procedures in FIGS. 1 to 16 comply with those described in the first embodiment.

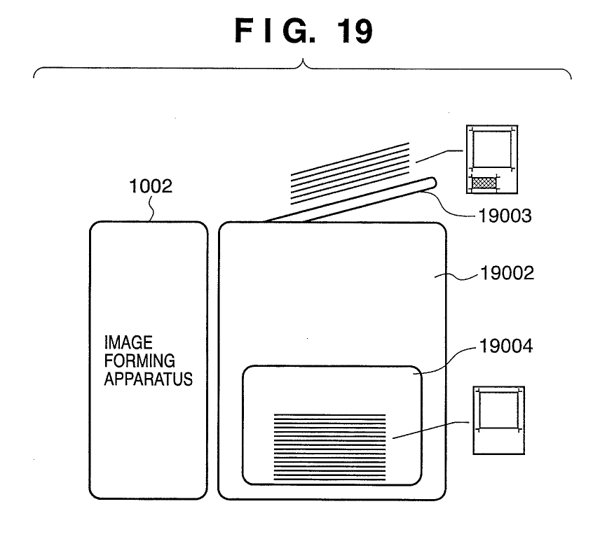

Prior to a description of the third embodiment, the structure of a printed sheet delivery section (discharge section) in an image forming apparatus 1002 will be explained with reference to FIG. 19.

FIG. 19 is a view showing the structure of the printed sheet delivery section according to the third embodiment of the present invention.

Reference numeral 19002 denotes a delivery control section for outputting a printed sheet from the image forming apparatus 1002 to a delivery tray. Reference numeral 19003 denotes a sample delivery tray mounted and exposed outside the housing of the delivery section. In the third embodiment, the sample delivery tray 19003 receives a printed sheet printing the composited image of an interrupted job. Reference numeral 19004 denotes a large-volume delivery tray incorporated in the housing of the delivery section. In the third embodiment, the large-volume delivery tray 19004 receives a sheet including the image of only a preceding job. The image forming apparatus 1002 comprises a plurality of discharge portions to discharge printed media. The image forming apparatus 1002 outputs sheets printing the images of preceding and interrupt jobs to a predetermined sample delivery tray.

The delivery portion is designated on the basis of a print job to be processed or information designated via an operation unit 4002.

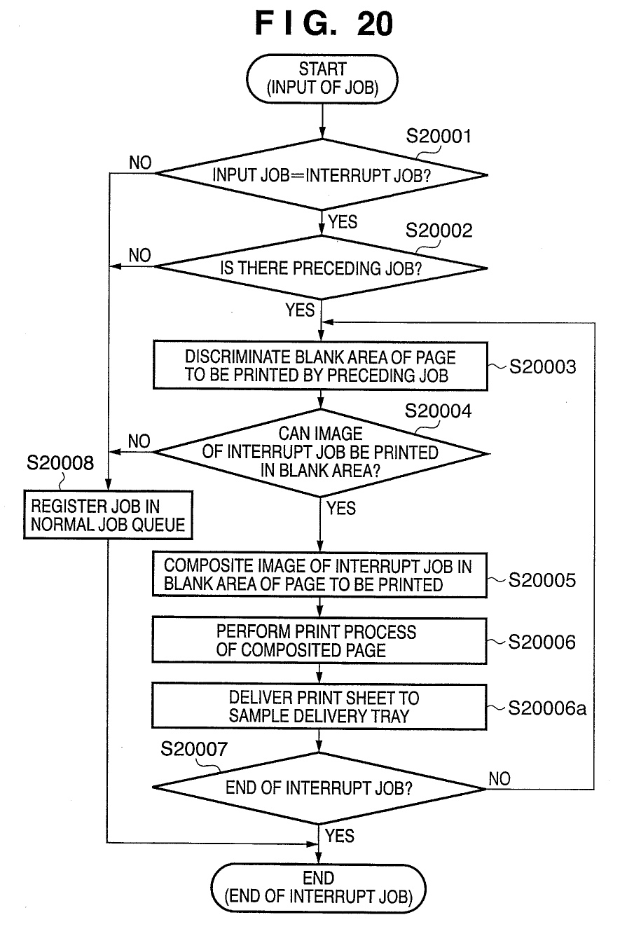

The print control process of the image forming apparatus 1002 according to the third embodiment will be explained with reference to FIG. 20.

FIG. 20 is a flowchart showing the print control process of the image forming apparatus according to the third embodiment of the present invention.

The print control procedures of the image forming apparatus 1002 according to the third embodiment will be explained with reference to the flowchart of FIG. 20.

Steps S20001 to S20006, S20007, and S20008 in FIG. 20 correspond to steps S16001 to S16006, S16007, and S16008 in FIG. 16 according to the first embodiment, and only the difference will be explained. In FIG. 20, a process in step S20006a is added to FIG. 16.

In step S20006a, the image forming apparatus 1002 controls to deliver, to the sample delivery tray 19003, a print result of compositing and outputting preceding and interrupt jobs in step S20006. More specifically, when the image forming apparatus 1002 composites preceding and interrupt jobs, it changes the delivery destination so as to deliver the print result to the sample tray.

As described above, according to the third embodiment, even when a preceding job requires a large number of output sheets, the operator can take out printed sheets of the interrupt job from the delivery section without opening/closing the door of the large-volume delivery section or the like. The operator can easily divide print results into composited and uncomposited results.

The output destination of a composited job is the sample tray in the third embodiment, but the present invention is not limited to this. The same effects as those described above can be obtained when the image forming apparatus 1002 discharges a combined job-based output result to a tray different from a tray designated as the output destination of a preceding job. For this purpose, the image forming apparatus 1002 temporarily stores the output destination tray of a preceding job, and designates another tray for a composited job.

### Fourth Embodiment

The fourth embodiment will be described with reference to FIGS. 1 to 16, 21, and 22.

Process procedures in FIGS. 1 to 16 comply with those described in the first embodiment.

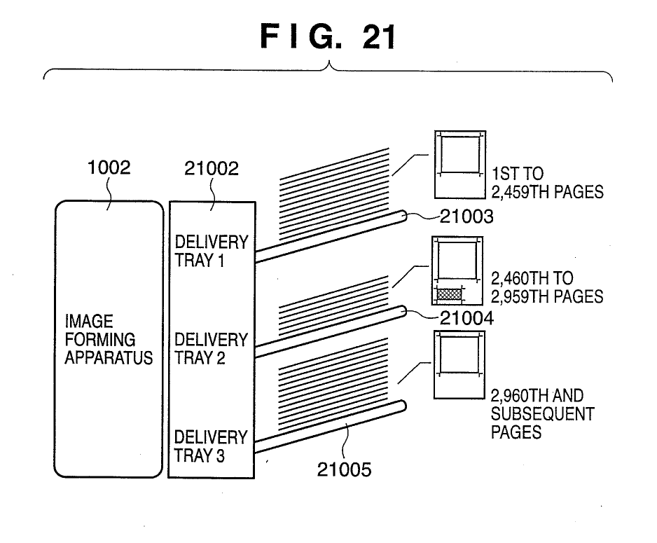

Prior to a description of the fourth embodiment, the structure of a printed sheet delivery section in an image forming apparatus 1002 will be explained with reference to FIG. 21.

FIG. 21 is a view showing the structure of the printed sheet delivery section according to the fourth embodiment of the present invention.

Reference numeral 21002 denotes a delivery control section for outputting a printed sheet from the image forming apparatus 1002 to a delivery tray.

Reference numeral 21003 denotes a first delivery tray in the delivery section. In the fourth embodiment, the first delivery tray 21003 receives printed sheets of a preceding job before printing of an interrupt job.

Reference numeral 21004 denotes a second delivery tray in the delivery section. The second delivery tray 21004 receives printed sheets after composition printing of preceding and interrupt jobs.

Reference numeral 21005 denotes a third delivery tray in the delivery section. In the fourth embodiment, the third delivery tray 21005 receives printed sheets of a preceding job after the completion of printing of an interrupt job.

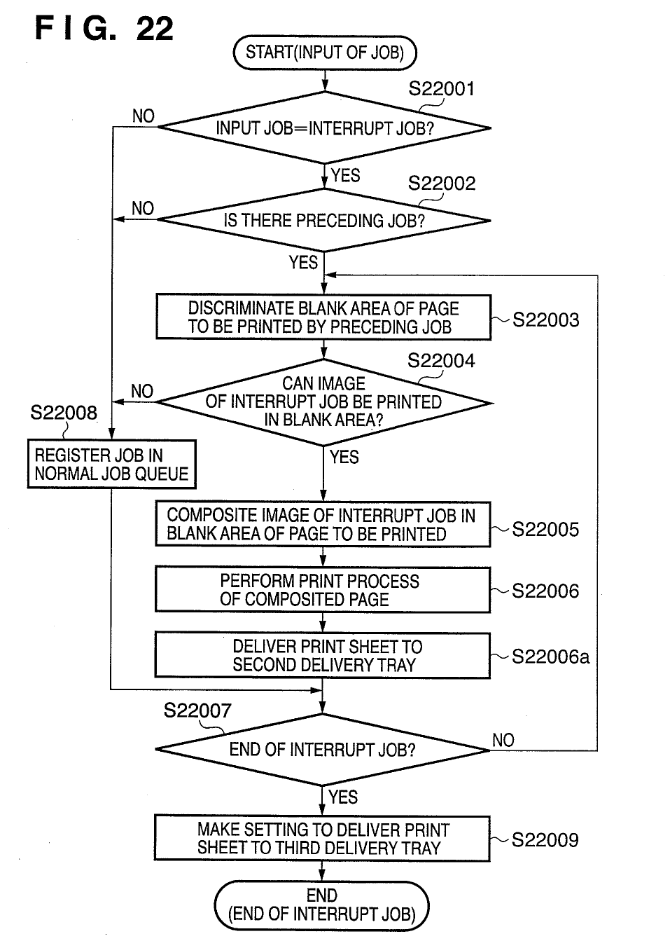

The print control process of the image forming apparatus 1002 according to the fourth embodiment will be explained with reference to FIG. 22.

FIG. 22 is a flowchart showing the print control process of the image forming apparatus according to the fourth embodiment of the present invention.

The print control procedures of the image forming apparatus 1002 according to the fourth embodiment will be explained with reference to the flowchart of FIG. 22.

Steps S22001 to S22006, S22007, and S22008 in FIG. 22 correspond to steps S16001 to S16006, S16007, and S16008 in FIG. 16 according to the first embodiment, and only the difference will be explained. In FIG. 22, processes in steps S22006a and S22009 are added to FIG. 16.

In step S22006a, the image forming apparatus 1002 controls to deliver, to the second delivery tray 21004, a print sheet printing the images of preceding and interrupt jobs composited in step S22006. As an example of the process in step S22006a, the image forming apparatus 1002 temporarily stores the output destination tray of the preceding job before composition, and discharges the output result of the composited job to another tray serving as an output destination.

After the process of step S22007, the image forming apparatus 1002 controls to set the third delivery tray 21005 as the delivery tray of the preceding job. As an example of the process in step S22009, the image forming apparatus 1002 temporarily stores the output destination tray of an uncomposited preceding job and that of a composited job, and discharges the output result of the composited preceding job to another tray as an output destination.

As described above, according to the fourth embodiment, when composition printing of preceding and interrupt jobs is done, print sheets before, during, and after composition printing can be delivered to different delivery portions. The operator can take out a printed material without any complicated sorting.

### Fifth Embodiment

In the first to fourth embodiments, when an interrupt job occurs, composition printing of the preceding and interrupt jobs is executed as much as possible. The fifth embodiment inhibits composition printing when print setting information such as the print sheet and print mode used for each job is different between a preceding job and an interrupt job. The print setting is given as job attribute information together with priority information described above.

For example, when the print sheet used for a preceding job is a glossy sheet and that used for an interrupt job is a plain sheet, composition printing of the two jobs with a print sheet used for either job may not attain an image quality intended by the user. Hence, when print sheets used for preceding and interrupt jobs are different, it is preferable not to execute composition printing even in a situation (e.g., YES in step S16004 of FIG. 16) in which composition printing is possible. In the first to fourth embodiments, the types of print sheets used for preceding and interrupt jobs may be determined before determining whether to execute composition printing. Only when the preceding and interrupt jobs use print sheets of the same type, composition printing may be executed.

As the job print mode, there are a print mode to determine the print quality such as high speed, high quality, or test print, and a print mode to determine the print color such as monochrome, grayscale, or color.

Also when the print mode is different between a preceding job and an interrupt job, the same problem as that when the print sheet for use is different may occur. To prevent this, in the first to fourth embodiments, the types of print modes used for preceding and interrupt jobs may be determined before determining whether to execute composition printing. Only when the preceding and interrupt jobs use the same print mode, composition printing may be executed.

More specifically, according to the fifth embodiment, when the setting contents of print setting items designated in print setting information for a preceding job and an interrupt job are different, an image forming apparatus 1002 controls to print the image of the preceding job and that of the interrupt job on different printing medium. For example, the image forming apparatus 1002 compares print setting information of a preceding job with that of an interrupt job. As a result of the comparison, the image forming apparatus 1002 controls execution/inhibition of composition printing of the preceding and interrupt jobs on the basis of designated print setting items (e.g., print sheet type, size, and print mode). The comparison can be executed on the basis of print setting information of a print job to be processed or information designated via an operation unit 4002.

A print sheet serving as a printing medium used in the present invention is not only paper used in a general printing apparatus, but widely includes cloth, a plastic film, a metal plate, and the like. The printing method is not limited to laser beam printing illustrated in FIG. 3, but various printing methods such as inkjet printing and thermal transfer printing are available.

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or script data supplied to an operating system.

Examples of storage media that can be used for supplying the program are a floppy disk, a hard disk, an optical disk, a magneto-optical disk, a CD-ROM, a CD-R, a CD-RW, a magnetic tape, a non-volatile type memory card, a RON, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user's computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-143384 filed on May 23, 2006, which is hereby incorporated by reference herein in its entirety.

What is claimed is:

1. An image forming apparatus which prints an image on a printing medium on the basis of a job associated with printing, comprising:
discrimination means for, when a second job to be processed by interrupting a first job is input, discriminating a blank area where a first image based on the first job is not laid out on a printing medium;
determination means for determining whether a second image based on the second job can be laid out in the blank area of the printing medium discriminated by said discrimination means; and
print control means for controlling printing so as to form the first image and the second image on the printing medium when said determination means determines that the second image can be laid out in the blank area on the printing medium.

2. The apparatus according to claim 1, wherein said discrimination means discriminates the blank area when print priority added to the second job input during a process of the first job is higher than print priority added to the first job.

3. The apparatus according to claim 1, further comprising cutting means for cutting a printing medium at a designated cutting position,
wherein when said determination means determines that the second image cannot be laid out in the blank area on the printing medium, said print control means controls printing of the first job and the second job so as to print on different printing medium, and
said cutting means cuts a medium printed by each job at a cutting position designated by the job.

4. The apparatus according to claim 1, further comprising:
storage means for storing information on printing medium of a plurality of sizes in the image forming apparatus; and
selection means for, when said determination means determines that the second image cannot be laid out in the blank area on the printing medium, selecting a printing medium capable of laying out the first image and the second image from printing medium stored in the image forming apparatus on the basis of printing medium information stored in said storage means,
wherein said print control means controls printing so as to form the first image and the second image on the printing medium selected by said selection means.

5. The apparatus according to claim 1, further comprising a plurality of discharge means for discharging printing medium having undergone a print process,
wherein said print control means controls to discharge printing medium on which the first image and the second image are printed to discharge means designated among said plurality of discharge means.

6. The apparatus according to claim 5, wherein
said plurality of discharge means include at least first discharge means mounted and exposed outside a housing, and second discharge means incorporated in the housing, and
said print control means discharges printing medium on which the first image and the second image are printed to said first discharge means among said plurality of discharge means.

7. The apparatus according to claim 5, wherein said print control means controls to discharge printing medium the first image and the second image are printed to first discharge means among said plurality of discharge means, and discharge printing medium on which the first image is only printed to second discharge means different from said first discharge means.

8. The apparatus according to claim 1, wherein when a setting content of a print setting item designated in print setting information is different between the first job and the second job, said print control means controls printing so as to print the first image and the second image on different printing medium.

9. The apparatus according to claim 8, wherein the print setting item includes at least one of a type and size of a printing medium, and a print mode.

10. A method of controlling an image forming apparatus which prints an image on a printing medium on the basis of a job associated with printing, comprising:
a discrimination step of, when a second job to be processed by interrupting a first job is input, discriminating a blank area where a first image based on the first job is not laid out on a printing medium;
a determination step of determining whether a second image based on the second job can be laid out in the blank area of the printing medium discriminated in the discrimination step; and
a print control step of controlling printing so as to form the first image and the second image on the printing medium when the second image is determined in the determination step to be able to be laid out in the blank area on the printing medium.

11. The method according to claim 10, wherein the discrimination step discriminates the blank area when print priority added to the second job input during a process of the first job is higher than print priority added to the first job.

12. The method according to claim 10, further comprising a cutting step of cutting a printing medium by a cutting unit at a designated cutting position,
wherein when the second image is determined in the determination step not to be able to be laid out in the blank area on the printing medium, said print control step controls printing of the first job and the second job so as to print on different printing medium, and
said cutting step cuts a medium printed by each job at a cutting position designated by the job by said cutting unit.

13. The method according to claim 10, further comprising:
a storage step of storing, in a storage medium, information on printing medium of a plurality of sizes in the image forming apparatus; and
a selection step of, when the second image is determined in the determination step not to be able to be laid out in the blank area on the printing medium, selecting a printing medium capable of laying out the first image and the second image from printing medium stored in the image forming apparatus on the basis of printing medium information stored in the storage medium in the storage step,
wherein said print control step controls printing so as to form the first image and the second image on the printing medium selected in the selection step.

14. The method according to claim 10, wherein said print control step controls to discharge printing medium on which the first image and the second image are printed to a discharge portion designated among the plurality of discharge portions.

15. The method according to claim 14, wherein
the plurality of discharge portions include at least a first discharge portion mounted and exposed outside a housing, and a second discharge portion incorporated in the housing, and
said print control step discharges printing medium on which the first image and the second image are printed to the first discharge portion among the plurality of discharge portions.

16. The method according to claim 14, wherein said print control step controls to discharge printing medium on which the first image and the second image are printed to first discharge portion among said plurality of discharge portions, and discharge printing medium on which the first image is only printed to second discharge portion different from said first discharge portion.

17. The method according to claim 10, wherein when a setting content of a print setting item designated in print setting information is different between the first job and the second job, said print control step controls printing so as to print the first image and the second image on different printing medium.

18. The method according to claim 17, wherein the print setting item includes at least one of a type and size of a printing medium, and a print mode.

19. A computer program which is stored in a computer-readable medium and causes a computer to control an image forming apparatus that prints an image on a printing medium on the basis of a job associated with printing, causing the computer to execute
a discrimination step of, when a second job to be processed by interrupting a first job is input, discriminating a blank area where a first image based on the first job is not laid out on a printing medium,
a determination step of determining whether a second image based on the second job can be laid out in the blank area of the printing medium discriminated in the discrimination step, and
a print control step of controlling printing so as to form the first image and the second image on the printing medium when the second image is determined in the determination step to be able to be laid out in the blank area on the printing medium.

20. An image forming apparatus which prints an image on a printing medium on the basis of a job associated with printing, comprising:
storage means for storing information on printing medium of a plurality of sizes in the image forming apparatus;
selection means for, when a second job to be processed by interrupting a first job is input, selecting a printing medium capable of laying out a first image based on the first job and a second image based on the second job on the basis of the printing medium information stored in said storage means; and
print control means for executing a print process based on the first image and the second image on the printing medium selected by said selection means.

21. A method of controlling an image forming apparatus which prints an image on a printing medium on the basis of a job associated with printing, comprising:
a selection step of, when a second job to be processed by interrupting a first job is input, selecting a printing medium capable of laying out a first image based on the first job and a second image based on the second job on the basis of information stored in a storage medium and indicating printing medium of a plurality of sizes in the image forming apparatus; and
a print control step of executing a print process based on the first image and the second image on the printing medium selected in the selection step.

22. A computer program which is stored in a computer-readable medium and causes a computer to control an image forming apparatus that prints an image on a printing medium on the basis of a job associated with printing, causing the computer to execute
a selection step of, when a second job to be processed by interrupting a first job is input, selecting a printing medium capable of laying out a first image based on the first job and a second image based on the second job on the basis of information stored in a storage medium and indicating printing medium of a plurality of sizes in the image forming apparatus, and
a print control step of executing a print process based on the first image and the second image on the printing medium selected in the selection step.
